(19) United States
(12) Patent Application Publication
(10) Pub. No.: US 2010/0325064 A1
(43) Pub. Date: Dec. 23, 2010

(54) SYSTEM, METHOD, AND COMPUTER PROGRAM PRODUCT FOR CALCULATING WITHDRAWAL AMOUNT UNDER GUARANTEED BENEFIT OF INVESTMENT PRODUCT USING MARKET-BASED VARIABLE RATE

(75) Inventor: Stephen J. Stone, Valley Village, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 12/817,806

(22) Filed: Jun. 17, 2010

Related U.S. Application Data
(60) Provisional application No. 61/218,326, filed on Jun. 18, 2009.

(51) Int. Cl. G06Q 40/00

(52) U.S. Cl. 705/36 R

(57) ABSTRACT

Systems, methods, and computer program products for determining a guaranteed benefit of an investment product include a means for changing an allowable withdrawal amount of the benefit associated with the guarantee based on a market-based interest rate that can be correlated to the hedging cost of the provider in funding the guarantee.

### CROSS-REFERENCE TO RELATED APPLICATIONS

This patent application claims the benefit of priority to U.S. Provisional Patent Application No. 61/218,326, filed on Jun. 18, 2009, and entitled “Market Based Variable Rate for Guaranteed Living Benefit on Insurance Products,” which is incorporated in its entirety herein by this reference.

### BACKGROUND OF THE INVENTION

Annuity products, which include, but are not limited to, variable annuities and contingent deferred annuities (CDA), and other investment products can provide guaranteed benefits on underlying investment products for investors based on certain time periods and/or contingencies such as death, loss of investment, poor health or depletion of the account from withdrawals. Guaranteed benefits on insurance/investment products, such as variable annuities, may further provide minimum returns on investments, often by guaranteeing a stream of withdrawals regardless of market performance These withdrawals may last for a set period or for the life of the investor or other designated covered person(s). Typically, the minimum withdrawal benefit rate is set at the time the product is issued and is the same for all investors, sometimes varying for a broadly defined class (e.g., age group).

There are various costs and risks associated with these guarantees, which an insurance company will typically hedge through investing activity in capital markets. One risk associated with such investments is the level of interest rates provided in markets in which the insurance provider invests capital. Moreover, differences in statutory and GAAP treatment of interest rate hedges may cause increased volatility in the level of statutory capital when implementing an effective hedging strategy.

### BRIEF SUMMARY OF THE INVENTION

This disclosure is directed to systems, methods, and computer program products for administering a guaranteed benefit of an investment product. Lower interest rates in capital markets result in a guaranteed benefit of an insurance/investment product that is more costly to provide and that requires increased hedging activity. The disclosure provides an investment product that allows for the guaranteed benefit associated therewith to be adjustable in response to hedging cost changes incurred while administering the product. For example, a benefit application can be used in a computing environment and can be embodied in computer readable media bearing instructions for determining the value of the benefit based upon at least one interest rate in a selected market.

In one embodiment, a system and method are described for varying future benefits by periodically determining permissible withdrawals based upon at least one market interest rate, which can be correlated with hedging costs associated with funding the benefit. Such indexing enables automatic adjustment of the guaranteed withdrawal rate wherein the permissible withdrawal amount for a given period is inversely related to the level of hedging costs associated with the product.

In one aspect of the disclosure, a withdrawal rate for the guarantee can be based on the rules and constraints of the guarantee. A withdrawal rate can be based on an index indicative of interest rates, which is correlated to hedging cost for the provider. As interest rates decrease in the capital markets used for hedging activity, the hedging cost for administering the product increases. An allowable withdrawal amount of the guarantee can be based upon the allowable withdrawal amount rate and an investment product value. The present disclosure provides an investment product that can allow for its administration to include a variable withdrawal rate structure which is inversely related to the cost of administering the product.

In one embodiment, withdrawals on a guaranteed minimum withdrawal benefit are based on a combination of a fixed rate, which may be based on the age of the beneficiary and/or the timing of a first withdrawal, and a market interest rate, which may be a publicly available interest rate or an indexed interest rate, such as, for example, the five-year treasury rate (H15T5Y). In a given withdrawal period, the withdrawal rate is calculated as a function of the fixed rate and the indexed interest rate.

In one aspect, the present disclosure describes a computer-implemented system for administering an investment product having a guaranteed benefit. A physical computer-readable medium includes an investment product benefit calculating program. A processor is adapted to execute the investment product benefit program contained on the physical computer-readable medium. The investment product program includes a calculating module having computer executable instruction adapted to determine an allowable withdrawal amount of the guaranteed benefit based upon at least one publicly-available interest rate.

In another aspect, the disclosure describes a method for administering an investment product having a guaranteed benefit. A processor is employed to execute computer executable instructions stored on a tangible computer-readable medium to calculate an allowable withdrawal amount of the guaranteed benefit based upon at least one publicly-available interest rate.

In yet another aspect, the disclosure describes a non-transitory, tangible computer-readable storage medium bearing instructions for administering an investment product having a guaranteed benefit. The instructions, when executing on one or more computing devices, perform the step of determining an allowable withdrawal amount of the guaranteed benefit is based upon at least one publicly-available interest rate.

As will be appreciated, the systems, methods, and computer program products disclosed herein are capable of being carried out in other and different embodiments, and capable of being modified in various respects. Accordingly, it is to be understood that both the foregoing general description and the following detailed description are exemplary and explanatory only and are not restrictive of the invention as claimed.

### BRIEF DESCRIPTION OF THE SEVERAL VIEWS OF THE DRAWINGS

FIG. 1 is a schematic diagram of an embodiment of a computer-implemented system for determining a guaranteed benefit of an investment product.

FIG. 2 is a schematic diagram of an embodiment of a computer-implemented system having a physical computer program product including computer-executable instructions for determining a guaranteed benefit of an investment product.

FIG. 3 is a flow diagram that illustrates an exemplary embodiment of a method of administering a guarantee in keeping with principles of the present disclosure.

FIG. 4 is a flowchart that illustrates steps of an exemplary embodiment of a method of administering a guarantee in keeping with principles of the present disclosure.

### DETAILED DESCRIPTION OF EMBODIMENTS OF THE INVENTION

Systems, methods, and computer program products for determining a guaranteed benefit of an investment product are described herein. In one aspect of the disclosure, a provider of a guarantee associated with an investment product can protect itself from loss by changing the benefit associated with the guarantee based on a market-based interest rate that can be correlated to the hedging cost of the provider in funding the guarantee.

In the following detailed description, references are made to the accompanying drawings that form a part hereof, and in which are shown by way of illustration, specific embodiments or examples. These embodiments may be combined, other embodiments may be utilized, and various changes may be made without departing from the spirit or scope of the present invention. The following detailed description is therefore not to be taken in a limiting sense.

Aspects of the present disclosure allow an insurance company or other institution (collectively, the “provider”) to reduce its risk in offering a guaranteed benefit on an underlying investment product to its customers by varying future withdrawal rates based on at least one publicly available interest rate. Embodiments of a system and a process are disclosed by which the withdrawal rate for a guaranteed benefit of any suitable investment product (collectively called the “guarantee”) is based on at least one hedging interest rate linked to the particular product. The invention is not limited in its application to annuity products with minimum guarantees. The guaranteed benefit may be included in any suitable investment product, including without limitation variable annuities and contingent deferred annuities (CDA) that are issued as individual and group, immediate and deferred annuities, for example. Furthermore, the systems, methods, and computer program products of the present invention are suitable for use with an investment product including any suitable guaranteed benefit, including, without limitation, a living benefit and a death benefit, for example.

One example of an annuity product is a variable annuity, which is a single product containing underlying investment options and a guarantee. Charges for the guarantee are associated with investment choices so that the guarantee charge is based on market conditions.

Another example is a contingent deferred annuity (CDA) that provides a guaranteed annuitization stream upon depletion of an underlying investment, subject to certain investment and withdrawal rules. The guarantee for the CDA is based on market conditions.

A further example is a variable annuity having a guaranteed minimum withdrawal benefit (GMWB) rider, the minimum guarantee for which is adjusted based on a factor correlated to market volatility associated with the cost of hedging activity related to capital the provider maintains to support the minimum benefit expenses. One example of a variable annuity product having a GMWB rider attached thereto is provided in U.S. Provisional Patent Application No. 61/148,622, filed on Jan. 30, 2009, and U.S. patent application Ser. No. 12/696,961, filed on Jan. 29, 2010, the contents of which are incorporated herein in their entireties by reference.

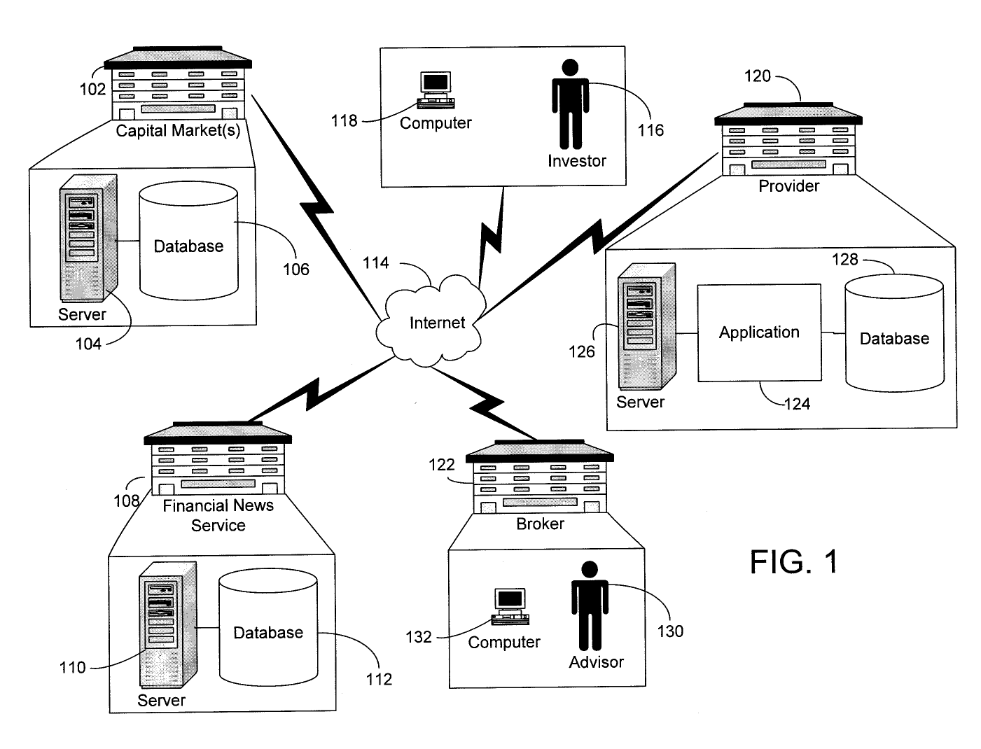

Turning now to the Figures, FIG. 1 is a general overview of a system architecture in keeping with the disclosed principles. In the illustrated embodiment, a capital market 102, for example, a stock or commodity exchange such as the New York stock exchange, a primary or secondary market dealing with treasury or corporate bonds, or any other such market, engages in secondary trading of stocks, commodities, bonds, and futures in the normal course of business.

As is known, the various transactions are recorded, and transaction data is analyzed to provide various numerical indicators of the state of the market, for example in one or more servers 104 storing and retrieving information from a database 106. In one embodiment, the capital market may be a sovereign entity, such as the U.S. Treasury, which issues treasury bonds at fixed interest rates and pay periods. In such embodiment, the capital market may be governed by a specified rate of return on the bonds. In general, markets may be characterized by periodic rates of return, which are determined based on value indices, such as the Dow Jones Industrial Average. In the case where Treasury rates are considered, the 5-year Treasury bond may be used or, alternatively, the five-year “on-the-run” Treasury rate, the 10-year Treasury rate, or any other available fixed-period Treasury rate or any other Treasury note or bond which bears a stated interest rate.

In addition to the interest rates already described, derivatives thereof may also be provided from trading in the secondary markets. For example, the interest rate used to settle any contract that is traded on a financial futures exchange as of a specified date. Examples of such rates include swap rates, Eurodollar rates, and the London Interbank Offer Rate (“LIBOR”). Examples of financial futures exchanges include the Chicago Mercantile Exchange (“CME”), the Chicago Board of Trade (“CBOT”), the London International Financial Futures Exchange (“LIFFE”), and the Singapore Exchange Limited.

Aggregate market data provided by the capital markets 102 is typically widely disseminated to the public via financial news services, such as the financial news reporting service 108. The financial news services 108 may collect raw or processed data from the capital markets 102, analyze such data as required by use of servers 110 and databases 112, and provide financial news reports and other collections of information to the public via printed or electronic channels of communication, for example, the Internet 114. One example of such disseminated information is the 5-year Treasury bond rate of return, or H15T5Y, which is announced on a regular, periodic basis in financial news.

An investor 116 having access to such information, for example, through the investor's computer 118, may receive such information from the internet 114 and make an informed decision as to whether the prevailing interest rates in the market are an important factor in the decision of the investor to purchase a guarantee from a provider 120. In the case where the investor 116 has made a purchase decision, the investor 116 may purchase a product with a minimum guarantee from the provider 120 via, for example, a broker 122.

When purchasing the investment product with the guarantee, a customer establishes an account with the broker 122 and purchases a guarantee from a guarantee provider 120, which is arranged to provide a minimum benefit that depends on a rate. Such rate includes a fixed component, and a variable component that depends on the prevailing market interest rate. The investment choices of the investor 116 may be a factor in determining the fees paid by the investor 116 for the guarantee, the rate at which the minimum benefit for the guarantee is calculated depends, at least in part, on the prevailing interest rate according to a predetermined function.

The variable component may have an initial value, which is determined at inception of the contract forming the guarantee. For example, the initial value may be the closing rate on the date the contract is established or the closing rate on the trading day immediately preceding the date the contract is established. Alternatively, the initial rate may be the rate at the end of the first trading day of the month or year in which the contract is established. The variable rate, in general, may be a snapshot value, or it may be a rate averaged over a predefined period (e.g., day, week, month, year) preceding or encompassing the date on which the contract is established, or it may be calculated over predetermined periods over the life of the annuity product.

In accordance with the present disclosure, the rate for calculating the minimum guaranteed benefit for the guarantee is based on the variable rate component, which may be determined or calculated as previously described, which generally represents the best feasible alternative for investment returns in any given market and which can be correlated to the cost of interest rate hedging of the provider.

In one embodiment, the provider 120 may receive financial news reports and prevailing or publicly available interest rate data or indices from the internet 114, and store those indices in the database 128 on a daily basis. These indices may be input to the application 124 operating on the server 126 to provide daily or otherwise periodic adjustments to rate used for calculating the minimum benefit for the guarantee. These periodic adjustments of the benefit rates may be provided to an investment advisor 130 via computer 132, and may additionally be provided directly to the investor 116 via computer 118.

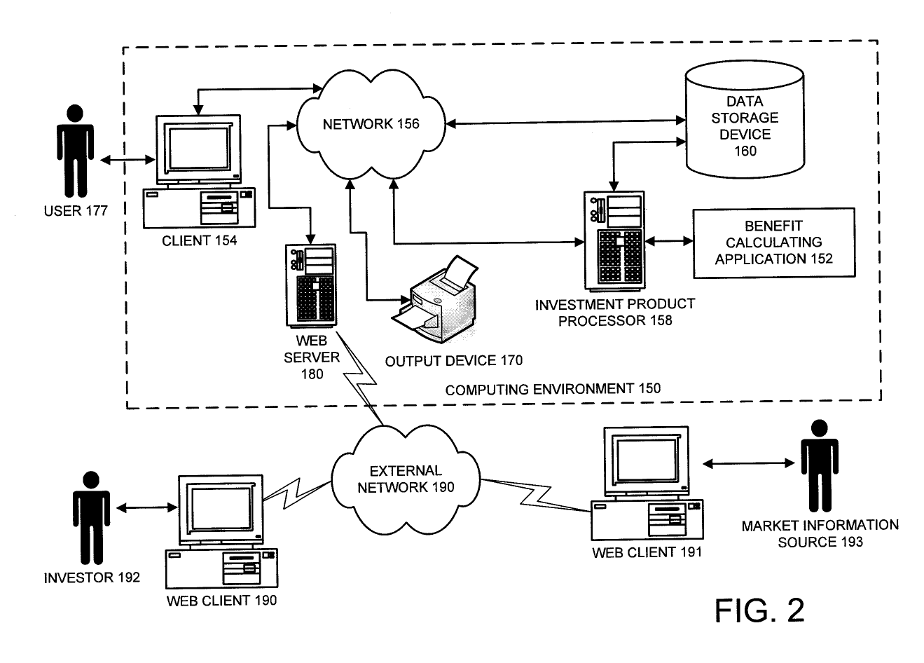

FIG. 2 is an embodiment of a computing environment 150 including an investment product benefit calculating application 152 for market-based valuation of a guaranteed benefit of an investment product. The computing environment 150 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 150 can include a client 154, an internal network 156, at least one investment product processor 158 operating the benefit calculating application 152, a data storage device 160, an output device 170, and a web server 180 operatively connected to an external network 190. The client 154, the investment product processor 158, the data storage device 160, the output device 170, and the web server 180 are operatively connected together via the internal network 130.

A plurality of web clients 190, 191 can use the computing environment 150 to interface with the provider operating the computing environment 150. For example, an investor 192 can use the web client 190 to receive information from, and to transmit information to, the provider's computing environment 150 about the underlying investment product. A market information source 193 can use the web client 191 to transmit market interest rate data from the web client 191 for use by the benefit calculating application 152. In other embodiments a different communication channel can be established between the capital markets, financial news services, vendors, etc. and the benefit calculating application 152 to transmit market data feeds to the benefit calculating application 152.

The client 154 can be used to communicate with an authorized user 177, to enter investment product account data into the data storage device 160, and/or to execute the benefit calculating application 152. The client 154 can comprise at least one input device. The client 110 can generally include any node on a network including computational capability and including a mechanism for communicating across the network 156.

In one embodiment, the client 154 hosts an application front end of the benefit calculating application 152. The application front end can generally include any component of the benefit calculating application 152 that can receive input from the user 177 or the client 154, communicate the input to the benefit calculating application 152, receive output from the benefit calculating application 152, and present the output to the user 177 or the client 154. In one embodiment, the application front end can be a stand-alone system.

The network 156 can generally include any type of wired or wireless communication channel capable of coupling together computing nodes. Examples of a suitable network 156 include, but are not limited to, a local area network, a wide area network, or a combination of networks.

The investment product processor 158 can generally include any computational node including a mechanism for servicing requests from a client for computational resources, data storage resources, or a combination of computational and data storage resources. Furthermore, the investment product processor 158 can generally include any system that can host the benefit calculating application 152. The investment product processor 158 can generally include any component of an application that can receive input from the web clients 190, 191 via the web server 180 and the client 154, process the input, and present the output to the benefit calculating application 152, the web server 180, and/or the data storage device 160. The investment product processor 158 can generally include any component of an application that can process data, interact with the data storage device 160, and execute business logic for the benefit calculating application 152.

The benefit calculating application 152 comprises a computer program product residing on a computer readable medium having a calculating module with a plurality of instructions stored thereon which, when executed by the investment product processor 158, cause the processor 158 to perform steps associated with periodically determining a benefit amount for an investment product having a guarantee wherein the benefit amount is determined based upon the prevailing rate of at least one interest rate that can be correlated to the cost of the provider's hedging activity to fund the benefit. Any suitable computer-readable storage medium can be utilized, including, for example, hard drives, floppy disks, CD-ROM drives, tape drives, zip drives, flash drives, optical storage devices, magnetic storage devices, and the like. The client 154 can be used by an authorized user 177 to help administer the benefit calculating application 152.

The database or data storage device 160 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment, the database 160 contains information associated with the various investment products provided by the provider and market interest rate information. This information can be used by the benefit calculating application 152 to periodically determine the benefit amount. The data storage device 160 can contain a permission database which stores user credentials and permissions specific to each user 177, investor 192, and market information source 193.

The output device 170 can comprise a printer, a display monitor, and a connection to another device, for example. The output device 170 can be used to generate reports for sending to the investment product owner which contain information generated by the benefit calculating application 152. The output device 170 can be used to communicate to the user 177 information about the investment products provided by the provider, which is generated by the benefit calculating application 152.

A report engine can be provided to generate displays of information stored in the data storage device 160 concerning the investment products provided by the provider, which can be viewed using the output device 170, for example. In one embodiment, the report engine further provides pre-configured and/or ad hoc reports relating to the benefit amount for investment products with a guarantee provided by the provider.

The web server 180 can provide a suitable web site or other Internet-based graphical user interface which is accessible by the investors (or his agent/broker) 192 and the market information sources 193 providing market interest rate data feeds, for example. The web clients 190, 191 can be connected to the web server 180 through the network connection 190 (e.g., Internet, Intranet, LAN, WAN and the like). The web server 180 can use an authentication server in order to validate and assign proper permissions to authorized users of the system. A permission database can store web user credentials and permissions specific to each user, investor, agent, broker, market information source, etc. The web server 180 can be outfitted with a firewall such that requests originating from outside the computing environment pass through the firewall before being received and processed at the web server 180.

In addition to the components discussed above, the computing environment 101 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

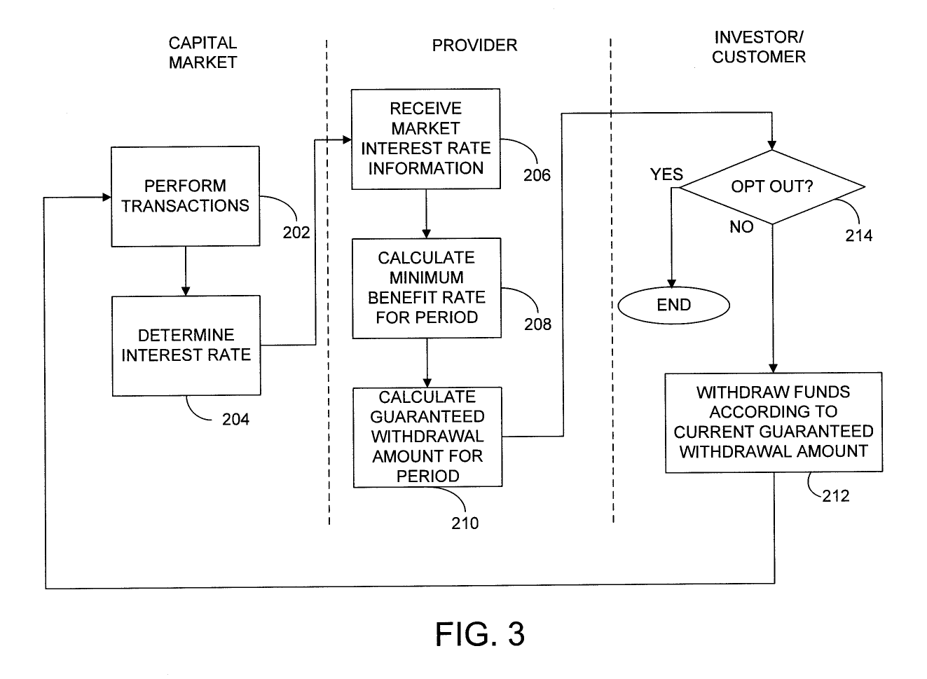

FIG. 3 is a flow diagram that illustrates an exemplary method of an aspect of the present disclosure. The illustrated method is partitioned into process steps occurring in three arenas, namely, the capital market, the provider, and the investor or customer. The process begins with transactions being performed at 202 by the capital markets. Such transactions are meant to generally encompass all relevant trading occurring at markets the provider may be using for benchmarking market volatility as used in the present disclosure. Data relevant to the transactions is analyzed, and along with other, external factors, an interest rate is determined at step 204. Regarding steps 202 and 204, these portions of the process occur in a large scale in the world of modern trading, and are simply illustrated for the purpose of discussion. For example, the interest rate determined at 204 may be an interest rate set by a sovereign as a stated rate of return on an initial offering of a treasury bond, or may alternatively represent a market price in secondary trading of such Treasury bond. In one embodiment, the interest rate may represent the market price for other types of bonds, such as corporate bonds.

More pertinent to the present discussion, interest rate information in the form of indexed or raw interest rate data are received by the provider at 206 in any suitable form, for example, in the form of electronic information being received via the Internet at one or more servers and being stored in one or more databases maintained by the provider. The market information received at 206 is processed and analyzed using appropriate software programs being executed in the servers of the provider to compute or yield revised rates with which to calculate the minimum guaranteed benefit rate for the period at step 208. Such rate revisions may be based on a multitude of factors, but for the purpose of the present disclosure, these revised fees are based on, in large part, market information, and specifically to market interest rates received at 206.

The provider calculates a revised guaranteed withdrawal amount at 210, which is based on the revised fees calculated at 208. The investor may withdraw funds according to the current guaranteed withdrawal amount for period at step 212. It is noted that, in one embodiment, the investor may receive periodic updates to the variable benefit withdrawal amounts calculated by the provider, or may alternatively be aware of a formula used to calculate the revised benefits such that the investor may perform an independent calculation by use of electronic computing means of the revised fee based on publicly accessible market interest rate information.

When calculating the revised withdrawal amount at 210, certain guidelines may be included within the initial agreement between the provider and the investor, which guidelines may outline and set limits to the variation of the minimum guarantee by contract. In one exemplary embodiment, a particular guaranteed minimum withdrawal benefit may be calculated based on a fixed rate (fixed_rate) and a variable rate which is linked to at least one publicly-available interest rate. For example, the guaranteed minimum withdrawal may depend on a market-based interest rate, for example, the one-year LIBOR “US0012M” or any other such rate as will be appreciated by one skilled in the art.

In one exemplary embodiment, the minimum guaranteed benefit rate (MGBR) is calculated in accordance with the following formula, which combines the described parameters and which illustrates that the MGBR includes a fixed rate component (FR) and a variable rate component (VR):

$$\begin{matrix}MGBR = FR + VR \\ = [ ( X / 100 ) * ( fixed\_rate ) ] + \\ = [ \frac{( 100 - X )}{100} * ( US 0012 M ) ]\end{matrix}$$

As can be seen from the above relationship, the fixed rate component (FR) is a function of a rate initially agreed upon at inception of the guarantee, which is adjusted based on typical factors used in conjunction with such products, such as the age of the beneficiary, the maturity of the product, and the remaining value of the product. The variable component (VR) of the MGBR depends on the complement of a policy factor X and is directly tied to a market-based interest rate, such as is the one-year LIBOR US0012M, for example, but which may alternatively be any other market-based interest rate or index.

In different embodiments, the policy factor X can have a value between zero and one hundred depending on the maturity of the product, the age of the beneficiary, and other factors. The value of X may change at set points, for example, when the account value has been depleted. In one embodiment, the value of X may be set to zero while the account value is greater than zero, and set to a non-zero value, for example, X=50, when the account value is less than or equal to zero.

The MGBR function may be transformed to its equivalent form:

MGBR=(X/100)×(fixed_rate−US0012M)+(US0012M)

which indicates that the MGBR will be at least equal to the market rate, when the market rate exceeds the fixed rate, and will be increased by a weighted difference between the fixed rate and the market rate.

In one embodiment, the contract forming the guarantee as described herein may contain a clause enabling the investor to opt out from the variable fee arrangement. Hence, an optional decision at 214 ends the process when the investor decides to invoke the opt out clause when such clause is included in his guarantee forming contract. If such a clause is not present, or if the investor decides not to invoke an opt out clause that is included in his contract, investor may elect to withdraw the funds at step 212, and the process may repeat for another period.

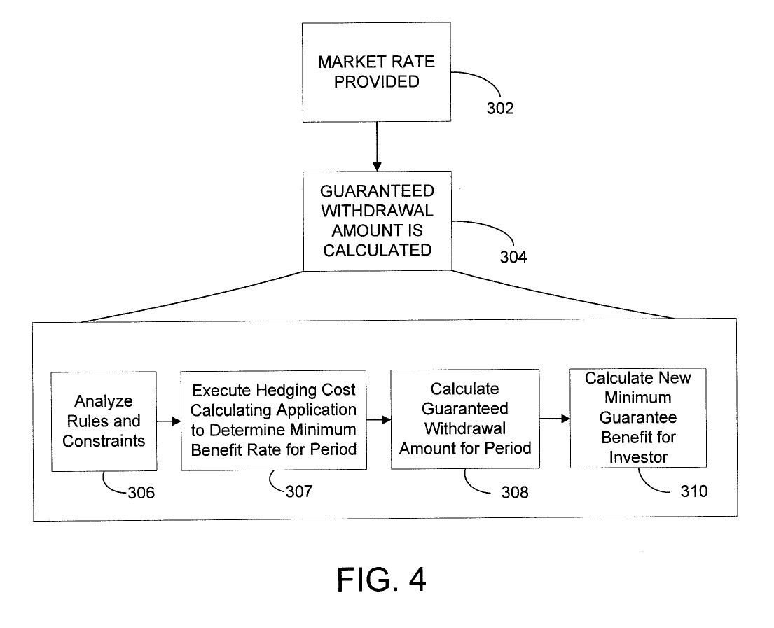

A flow chart illustrating a few of the sub steps or sub-processes executed by a software algorithm operating in the servers of the provider and computing a new or revised minimum guarantee benefit is shown in FIG. 4. A new or updated market rate, or alternatively new and/or updated market interest rate information, is made available to the provider at 302. The market interest rate is used to calculate a new minimum guarantee benefit at 304 by use of a spreadsheet application or a specialized software application, each of which may be operating in the servers or computer systems of the provider. Steps 306, 308, and 310, the description of which follows, are sub steps that are included in the calculation of the new minimum guarantee benefit at 304.

More specifically, at 306, various rules and constraints, such as clauses included in the initial agreement between the provider and the investor, are examined. At a step 307, market data provided at 302 is placed in a hedging file, and a hedging cost calculation algorithm is executed using such data to calculate the minimum benefit rate for the current period. A guaranteed withdrawal amount for the period is calculated at 308. This calculation may include a function containing weighted or raw components contributing to the rate, including fixed and variable portions. The variable portion thereof may be a prevailing market rate at the time of withdrawal of the benefit, or may alternatively by a rolling average of market interest rates that were effective over a predetermined period, for example, 30 days, or any other benefit withdrawal period intervening since a last withdrawal was made. The adjusted rate is used to compute a new minimum guaranteed benefit for the investor corresponding to a particular benefit period at 310. As previously described, the new benefit may include a base benefit plus any adjustments stemming from changes to the values of the market interest rate being tracked by the provider.

It would be apparent to a person of ordinary skill in the art that embodiments of the invention include changing charges and benefits for the investment products described herein for one or more customers. Consequently, aspects of the exemplary computer system and computer implemented method described in the disclosure allow a provider to calculate the charges and benefits for the investment products described herein for its many customers and the many different market conditions that may appear during the life of a guarantee. In addition, embodiments of the invention physically transform (by either increasing or decreasing) the minimum guaranteed benefits. Hence, the money received by the provider, for the investment products described herein based on changing market conditions. The provider may notify a change in charge to each customer through means described in the disclosure as well as by a physical invoice.

In other embodiments, systems and methods for administering an investment product having a guaranteed benefit may be implemented on various types of computer architectures, such as for example on a single general purpose computer or workstation, or on a networked system, or in a client-server configuration, or in an application service provider configuration. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor can include but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality (e.g., the golden copy security pricing compilation functionality) may be located on a single computer or distributed across multiple computers depending upon the particular circumstances surrounding its use (e.g., located on client and/or server computers).

In various embodiments, methods for administering an investment product having a guaranteed benefit in accordance with the principles of the present disclosure operate as software programs running on a computer processor. Dedicated hardware implementations including, but not limited to, application-specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

In various embodiments, an investment product benefit calculating program in accordance with the principles of the present disclosure can take the form of a computer program product on a tangible, computer-readable storage medium having computer-readable program code means embodied in the storage medium. The software implementations of the program for determining a benefit amount based upon at least one interest rate as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, a tangible storage medium includes a distribution medium and art-recognized equivalents and successor media, in which the software implementations herein are stored.

The present invention has been described in particular detail with respect to a limited number of embodiments. Those of skill in the art will appreciate that the invention may additionally be practiced in other embodiments. The particular naming of the components, capitalization of terms, the attributes, data structures, or any other programming or structural aspect is not mandatory, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware or hardware, and when embodied in software, can be downloaded to reside on and be operated from different platforms used by real time network operating systems.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. It should be understood that a variety of programming languages may be used to implement the teachings of the present disclosure as described herein, and any references to specific languages are exemplary to aid one skilled in the art to make and use the invention.

The language used in the specification has been principally selected for readability and instructional purposes. Accordingly, the disclosure is intended to be illustrative, but not limiting, of the scope of the invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. For example, embodiments of the invention can be applied to any form of investment insurance that allows for investments in a finite set of alternatives. Other embodiments of the invention can be applied to 403(b) accounts, 401(k) accounts, and non-VA guarantees on mutual funds or other investments.

The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented system for administering an investment product having a guaranteed benefit comprising:
a physical computer-readable medium including an investment product benefit calculating program; and
a processor adapted to execute the investment product benefit program contained on the physical computer-readable medium;
wherein the investment product program includes a calculating module having computer executable instruction adapted to determine an allowable withdrawal amount of the guaranteed benefit based upon at least one publicly-available interest rate.

2. The system of claim 1, wherein the calculating module is adapted to determine the allowable withdrawal amount based upon a fixed component and a variable component that varies based upon at least one publicly-available interest rate.

3. The system of claim 1, wherein at least one interest rate of the calculating module is correlated to the cost of interest rate hedging used to fund the guaranteed benefit.

4. The system of claim 1, wherein at least one interest rate of the calculating module is a U.S. Treasury bond interest rate.

5. The system of claim 1, wherein the calculating module is adapted to determine an allowable withdrawal amount rate based upon a formula including at least one publicly-available interest rate.

6. The system of claim 5, wherein the calculating module is adapted to determine the allowable withdrawal amount based upon the allowable withdrawal amount rate and an investment product value.

7. The system of claim 6, wherein the investment product value comprises at least one of an account value related to actual contributions made to the investment product and a benefit base value related to a predetermined set of conditions of the investment product.

8. A method for administering an investment product having a guaranteed benefit comprising, employing a processor to execute computer executable instructions stored on a tangible computer-readable medium to perform a step of:
calculating an allowable withdrawal amount of the guaranteed benefit based upon at least one publicly-available interest rate.

9. The method of claim 8, wherein the allowable withdrawal amount is calculated based upon a fixed component and a variable component that varies based upon at least one publicly-available interest rate.

10. The method of claim 8, wherein the allowable withdrawal amount is calculated using at least one interest rate that is correlated to the cost of interest rate hedging used to fund the guaranteed benefit.

11. The method of claim 8, wherein the allowable withdrawal amount is calculated using a U.S. Treasury bond interest rate.

12. The method of claim 8, wherein the allowable withdrawal amount is calculated using an allowable withdrawal amount rate based upon a formula including at least one publicly-available interest rate and an investment product value.

13. The method of claim 12, wherein the investment product value comprises at least one of an account value related to actual contributions made to the investment product and a benefit base value related to a predetermined set of conditions of the investment product.

14. The method of claim 8, wherein the computer executable instructions stored on the tangible computer-readable medium perform a step of:
periodically re-calculating the allowable withdrawal amount based upon at least one publicly-available interest rate prevailing at a designated time in relation to the time of re-calculation.

15. A tangible computer-readable storage medium bearing instructions for administering an investment product having a guaranteed benefit, the instructions, when executing on one or more computing devices, perform the step of:
determining an allowable withdrawal amount of the guaranteed benefit is based upon at least one publicly-available interest rate.

16. The computer-readable storage medium of claim 15, wherein the allowable withdrawal amount is calculated based upon a fixed component and a variable component that varies based upon at least one publicly-available interest rate.

17. The computer-readable storage medium of claim 15, wherein the allowable withdrawal amount is calculated using at least one interest rate that is correlated to the cost of interest rate hedging used to fund the guaranteed benefit.

18. The computer-readable storage medium of claim 15, wherein the allowable withdrawal amount is calculated using a U.S. Treasury bond interest rate.

19. The computer-readable storage medium of claim 15, wherein the allowable withdrawal amount is calculated using an allowable withdrawal amount rate based upon a formula including at least one publicly-available interest rate and an investment product value.

20. The computer-readable storage medium of claim 19, wherein the investment product value comprises at least one of an account value related to actual contributions made to the investment product and a benefit base value related to a predetermined set of conditions of the investment product.

21. The computer-readable storage medium of claim 15, wherein the computer executable instructions perform a step of:
periodically re-calculating the allowable withdrawal amount based upon at least one publicly-available interest rate prevailing at a designated time in relation to the time of re-calculation.
